(19) United States
(12) Patent Application Publication
(10) Pub. No.: US 2019/0340318 A1
(43) Pub. Date: Nov. 7, 2019

(54) SYSTEMS AND METHODS FOR CREATION OF MULTISCALE SIMULATIONS

(71) Applicant: Lexma Technology, LLC, Arlington, VA (US)

(72) Inventor: Simone Melchionna, Belmont, MA (US)

(21) Appl. No.: 16/402,928

(22) Filed: May 3, 2019

Related U.S. Application Data
(60) Provisional application No. 62/790,031, filed on Jan. 9, 2019.
(60) Provisional application No. 62/783,324, filed on Dec. 21, 2018.
(60) Provisional application No. 62/666,844, filed on May 4, 2018.

(51) Int. Cl. G06F 17/50; G06T 13/20; G06T 7/00

(52) U.S. Cl. CPC G06F 17/5009; G06T 7/0012; G06T 13/20

(57) ABSTRACT

The invention generally relates to systems and methods for creating visualizations, including multiscale simulations of a biological concept or process.

### CROSS-REFERENCE TO RELATED APPLICATION(S)

This application claims priority to, and the benefit of, U.S. Provisional Application No. 62/666,844, filed on May 4, 2018, U.S. Provisional Application No. 62/783,324, filed Dec. 21, 2018, and U.S. Provisional Application No. 62/790,031, filed Jan. 9, 2019, the contents of each of which are incorporated by reference herein in their entireties.

### FIELD OF THE INVENTION

The invention generally relates to systems and methods for creating visualizations, including multiscale simulations of a biological concept or process.

### BACKGROUND

Scientists typically rely upon a range of visual depictions to describe different aspects of a scientific concept. For example, illustrations, diagrams, animations, and interactive learning tools are increasingly used to make sense of biological systems, including molecular and cellular phenomena. As such, models are central to what scientists do, both in their research as well as when communicating their explanations. One application of scientific modelling is the field of simulation, which has a spectrum of applications, ranging from concept development and analysis, through experimentation, and measurement and verification. Any given project may use hundreds of different simulations, simulators, and model analysis tools.

The modelling of biological systems can be a particularly difficult task. For example, the study of proteins in cell-like environments may be challenging as a result of the interplay of the cause-and-effect among the protein molecules and the surrounding fluid. For example, the cell interior is composed of several compartments, which may include any closed part embedded within the cytosol, typically surrounded by membranes, such as in the case of organelles. Organelles are specialized subunits that carry distinct functions, ranging from energy production to translation, folding, as well as sorting and packaging of proteins. Some common examples of organelles include mitochondria, ribosomes, the Golgi apparatus or the endoplasmic reticulum. In order to execute their function, organelles display complex structures and internal organizations of large sets of proteins, whose type is closely related to the containing unit.

While current work in the field of biological simulation attempts to model the interior of cell-like environments, such simulations are based on drastic simplifications and neglect solvent-mediated interactions. Accordingly, the main computational challenge raised by biological systems remains the wide and disparate range of spatiotemporal scales involved in their dynamical evolution, such that current simulation systems and methods are unable to accurately model and simulate certain complex biological processes, including, but not limited to, protein folding, morphogenesis, and intra- and extracellular communication.

### SUMMARY

The present invention recognizes the complexities of biological systems and processes, particularly within a cellular environment, and provides simulation systems and methods to account for such complexities. In particular, the present invention includes systems and methods for providing multiscale simulations of biological systems and processes that involve a disparate range of spatiotemporal scales, such as those composed of colloidal particles or polymers moving in a fluidic molecular environment.

The systems and methods utilize a multiscale modeling framework to account for dynamics of a structure (e.g., particle, molecule, etc.) with dynamics of a surrounding fluid (e.g., solvent) and the mutual exchange of forces upon one another across various spatial scales. For example, the modeling framework may be based off of one or more digital models having a hierarchical multigrid structure including one or more layers, each layer being representative of the structure and/or fluid at a specific spatial scale. Each layer of the multigrid structure may further be defined by a plurality of individual and independent spatial regions. The systems and methods are configured to account for movement of the structure and/or the fluid in any one of the spatial regions, and, in turn, interconnect layers of the multigrid structure, such that movement at a first layer is synchronized with movement at a second layer in each of the plurality of individual and independent spatial regions, and further interconnect the plurality of individual and independent spatial regions. Based on the interconnections, the systems and methods are configured to generate a multiscale simulation accurately depicting the interplay of the cause-and-effect among a structure and the surrounding fluid, such as a protein molecule within a surrounding solvent in a cell-like environment.

The systems and methods of the present invention are able to address multiscale and multiphysics problems that current modeling and simulation systems fail to address when attempting to simulate biological processes. By accurately accounting for the interplay of the cause-and-effect among a structure and a surrounding fluid, the systems and methods of the present invention allow for simulations of a wide variety of complex biological systems and processes, and thus present numerous fields of application. For example, the present invention can improve drug discovery and development, in that the present invention allows for simulation of biochemical transitions activated by surrounding flows, including unfolding, refolding, allostery, cleavage, and substrate binding, which can allow for the virtual assessment of drug performance before engaging experimental studies, which can be costly and time-consuming. The present invention can further improve the study and treatment of diseases by allowing for the simulation of large-scale biological solutions unveiling molecular recognition, diffusive processes, signaling pathway, diffusion in cell-like environments. Furthermore, the systems and methods of the present invention can be used as a non-invasive diagnostics tool, in that physiological flows in complex conduits (as reconstructed from 3-D or 2-D medical imaging) can be simulated, thereby enabling the characterization of blood streams in cardiovascular and cerebral networks, as well as airflow in nasal and pulmonary air-paths, for example.

Aspects of the invention may be accomplished by using a web portal or user interface (UI) to receive user input and to further return a simulation based on user input. The user input may include user selection of one or more structures and/or fluids to undergo simulation, as well as user selection of one or more parameters for influencing movement of the structure and/or fluid during simulation. The systems and methods of the invention may create a multiscale simulation using models stored in a database, in which each model includes scientifically accurate structural data, behavioral data, animation data, and structure or fluid dynamics (depending on whether the model corresponds to a structure or a fluid) associated with a structure or a fluid. The models are built based on scientific information, such as publicly-available data repositories including experimentally-determined data, including structure, dynamics, and the like, for a particle or fluid. The models can be used in creating animated simulations. The structural data provides that the depicted structure and/or fluid will be scientifically accurate and the behavioral, animation, and/or dynamics data provides scientifically accurate range-of-motion or dynamic information so that the animations will illustrate interactions with desired accuracy. Since the structure and fluid models are stored in a database, the system can use them as-is—that is, the models are “ready for use” in building animations and a user need not manipulate files in order to confer accurate dynamics on the depicted structure or fluid. Selected entries from a model database can be imported into an animation platform to create animations that may be used, in turn, to create digital media, such as simulations, or other interactive media. Thus, a scientist, or other user, can simply use a web portal or a UI to create a simulation that depicts a scientific concept, such as a complex biological process, that is being studied in accordance with the systems and methods of the present invention, thereby simplifying the process.

Certain aspects of the invention relate to systems and methods for providing a multiscale simulation. In one embodiment, the method comprises defining a visual representation as a plurality of individual and independent spatial regions and further defining, for at least one of the individual and independent spatial regions, movement of a structure and/or a fluid within the at least one of the individual and independent spatial regions at a first layer at a first spatial scale and at a second layer at a second spatial scale. The method further comprises interconnecting the first and second layers so that movement at the first layer is synchronized with movement at the second layer in each of the plurality of individual and independent spatial regions. The method further includes interconnecting the plurality of individual and independent spatial regions, thereby generating a multiscale simulation of the visual representation.

In some embodiments, the structure is a biomolecule and the fluid is a solvent, such that the spatial scale is atomistic. However, in other embodiments, the structure is a larger particle, such as a whole red blood cell, and the spatial scale is micrometric. The visual representation of the structure and/or the fluid within the at least one of the individual and independent spatial regions at the first layer is generated from a first set of data and visual representation of the structure and/or the fluid within the at least one of the individual and independent spatial regions at the second layer is generated from a second set of data. The interconnecting of the first and second layers comprises associating the first set of data with the second set of data, wherein each of the first and second sets of data comprises structural data, dynamic data, behavioral data, and animation data associated with the structure and/or the fluid within the at least one of the individual and independent spatial regions. The simulation of the visual representation generally includes an animation that depicts an interaction of the structure with the fluid and/or an interaction of the structure with another structure. The movement of the structure and/or the fluid is generally based on the animation data. As such, the animation data defines animation dynamics of or more portions of the structure and/or fluid based, at least in part, on one or more of the structural data, dynamic data, and behavioral data. At least one of the structural data, dynamic data, behavioral data, and animation data are sourced from one or more scientific data sources and the animation data allows for one or more portions of the structure to be deformed into one of a plurality of scientifically accurate poses.

In another embodiment, a system for providing a multiscale simulation is provided, the system comprising a processor coupled to a memory containing instructions executable by the processor to cause the system to store a plurality of components associated at least one of a structure and a fluid to undergo simulation and a plurality of parameters for influencing movement of at least one of the structure and the fluid during simulation. The system is further configured to receive, via a graphical user interface, a request from a user, the request comprising selection of one or more components and one or more parameters. The system is further configured to define a visual representation as a plurality of individual and independent spatial regions based on the selected one or more components and parameters and define, for at least one of the individual and independent spatial regions, movement of a structure and/or a fluid within the at least one of the individual and independent spatial regions at a first layer at a first spatial scale and at a second layer at a second spatial scale. The system is further configured to define, for the at least one of the individual and independent spatial regions, movement of the structure within the fluid based on a combination of structure dynamics and fluid dynamics so that movement of the structure within the fluid is based on interplay between the structure dynamics and the fluid dynamics. The interplay is based on the structure exerting a density of field upon the fluid proportional to a gradient and the fluid exerting a density of field upon the structure proportional to the gradient. The system is then configured to interconnect the first and second layers so that movement at the first layer is synchronized with movement at the second layer in each of the plurality of individual and independent spatial regions. The system is then configured to interconnect the plurality of individual and independent spatial regions, thereby generating a multiscale simulation of the visual representation.

In some embodiments, the structure dynamics is based on Molecular Dynamics (MD) modeling and the fluid dynamics is based on Lattice Boltzmann (LB) modeling. However, it should be noted that other structure and fluid dynamics may be relied upon and the system is not limited to MD and/or LB modeling. The visual representation of the structure and/or the fluid within the at least one of the individual and independent sectors at the first layer may be generated from a first set of data and visual representation of the structure and/or the fluid within the at least one of the individual and independent sectors at the second layer is generated from a second set of data. Interconnecting the first and second layers may include associating the first set of data with the second set of data, wherein each of the first and second sets of data may include structural data, behavioral data, animation data, structure dynamics, and fluid dynamics associated with the structure and/or the fluid within the at least one of the individual and independent sectors. The simulation of the visual representation generally includes an animation that depicts an interaction of the structure with the fluid and/or an interaction of the structure with another structure. The movement of the structure and/or the fluid is generally based on the animation data. The animation data defines animation dynamics of or more portions of the structure and/or fluid based, at least in part, on one or more of the structural data, dynamic data, and behavioral data in combination with the interplay between the structure dynamics and fluid dynamics. At least one of the structural data, dynamic data, behavioral data, and animation data are sourced from one or more scientific data sources and the animation data allows for one or more portions of the structure to be deformed into one of a plurality of scientifically accurate poses. One or more of the plurality of parameters for influencing movement of at least one of the structure and the fluid during simulation may be pre-programmed and one or more of the plurality of parameters may be user-definable such that the system is configured to receive, via the graphical user interface, user-defined parameter settings and further configured to generate a simulation based on the selected one or more components the selected user-defined parameter settings.

Other aspects of the invention provide methods for simulating movement of a structure in a visual representation. In one embodiment, the method comprises receiving data associated with a structure in a fluid and defining at least a first layer and a second layer of the structure in the fluid. The first layer comprises a visual representation of movement of the structure in the fluid at a first spatial scale and the second layer comprises a visual representation of movement of the structure in the fluid at a second spatial scale. The method further comprises generating a multiscale simulation of movement of the structure by interconnecting the first and second layers of the structure by associating the visual representation of the movement of the structure in the fluid at the first spatial scale with the visual representation of the movement of the structure in the fluid at the second spatial scale.

In some embodiments, the structure is a biomolecule and the fluid is a solvent, such that the spatial scale is atomistic. However, in other embodiments, the structure is a larger particle, such as a whole red blood cell and the fluid is serum, and the spatial scale is micrometric. In some embodiments, the first layer of the structure in the fluid is generated from a first set of data and the second layer of the structure in the fluid is generated from a second set of data. The interconnecting of the first and second layers of the structure may include associating the first set of data with the second set of data. Each of the first and second sets of data may generally include structural data, dynamic data, behavioral data, and animation data associated with at least the structure. The simulation of the visual representation may include an animation depicting an interaction of the structure with the fluid and/or an interaction of the structure with another structure. The movement of the structure and/or the fluid may be based on the animation data. The animation data may define animation dynamics of or more portions of the structure and/or fluid based, at least in part, on one or more of the structural data, dynamic data, and behavioral data. At least one of the structural data, dynamic data, behavioral data, and animation data are sourced from one or more scientific data sources and the animation data allows for one or more portions of the structure to be deformed into one of a plurality of scientifically accurate poses.

In another embodiment, the method comprises receiving data associated with a structure in a fluid and defining a visual representation of movement of at least the structure within the fluid based on a combination of a first set of data comprising structure dynamics and a second set of data comprising fluid dynamics so that movement of the structure within the fluid is based on interplay between the structure dynamics and the fluid dynamics. The interplay is based on the structure exerting a density of field upon the fluid proportional to a gradient and the fluid exerting a density of field upon the structure proportional to the gradient. The method further comprises generating a simulation of movement of at least the structure within the fluid based on the defined visual representation.

In some embodiments, the structure dynamics is based on Molecular Dynamics (MD) modeling and the fluid dynamics is based on Lattice Boltzmann (LB) modeling. However, it should be noted that other structure and fluid dynamics may be relied upon and the system is not limited to MD and/or LB modeling. Each of the first and second sets of data may further include structural data, behavioral data, and animation data associated with the structure and the fluid, respectively. The simulation of the visual representation may include an animation depicting an interaction of the structure with the fluid and/or an interaction of the structure with another structure. The simulation of the visual representation may include an animation depicting movement of the structure within the fluid. The movement of the structure and/or the fluid may be based on the animation data. The animation data may generally define animation dynamics of or more portions of the structure and/or fluid based, at least in part, on one or more of the structural data, dynamic data, behavioral data, and structure dynamics or fluid dynamics. At least one of the structural data, behavioral data, animation data, and structure dynamics or fluid dynamics are sourced from one or more scientific data sources and the animation data allows for one or more portions of the structure to be deformed into one of a plurality of scientifically accurate poses.

### BRIEF DESCRIPTION OF THE DRAWINGS

FIG. 1 is a block diagram illustrating one embodiment of an exemplary system for providing a multiscale simulation.

FIG. 2 is a block diagram illustrating the simulation system of FIG. 1 in greater detail.

FIG. 3 is a block diagram illustrating a simulation file in greater detail.

FIGS. 4A and 4B illustrate a hierarchal multigrid structure of a digital simulation file used in the multiscale modeling framework of the simulation system of FIG. 1.

FIG. 4C illustrates multiple layers of a multigrid structure of a simulation file, further illustrating the plurality of individual and independent spatial regions at each layer and the interconnecting of layers of the multigrid structure, such that movement at a first layer is synchronized with movement at a second layer in each of the plurality of individual and independent spatial regions, thereby allowing for scale coupling and generation of a multiscale simulation.

FIG. 5 illustrates an exemplary composition containing proteins within a solvent, illustrating the different forces that must be accounted for in order to provide an accurate simulation of protein and/or fluid movement based on the interplay of the cause-and-effect among the protein molecules and the surrounding solvent across different spatial scales.

FIGS. 6A-6F illustrate a multiscale simulation of molecular nanotranslocation.

FIG. 7 illustrates a multiscale simulation of vesicular firing.

FIGS. 8A and 8B illustrate a multiscale simulation of flow-activated protein transitions in blood coagulation.

FIGS. 9A-9C illustrate a multiscale simulation of quantitative enzymatic characterization.

FIGS. 10A-10E illustrate a multiscale simulation of red blood cells and plasma in 3D scanned coronary arteries.

FIGS. 11A-11D illustrate a multiscale simulation of airflow within a nasal cavity in 3D scanned respiratory tracts. FIG. 11E illustrates a multiscale simulation of diffusion of olfactory tracers within a nasal cavity in 3D scanned respiratory tracts.

FIG. 12 illustrates a multiscale representation of vesicles transporting proteins.

### DETAILED DESCRIPTION

The invention generally relates to systems and methods for creating visualizations, particularly visual representations for illustrating a scientific concept. The visual representation may include a single digital asset or a plurality of digital assets. For purposes of discussion, and ease of explanation, the exemplary systems and methods described herein refer to the creation of visual representations in the form of computer simulations illustrating a biological concept or process, which includes animated models. However, it should be noted that the systems and methods described herein may be configured to generate other types of visual representations, including, but not limited to, pictures, animations, interactives, games, and other media. In some embodiments, a visual representation may further provide a visual narrative of a scientific concept so as to convey a scientific concept to an audience without the use of any text.

It should further be noted that, while the following description focuses on use of the systems and methods of the present invention for life science-related applications (i.e., for generating simulations a biological concept or process), systems and methods of the present disclosure can also be applied to other fields and are not limited to the life sciences, specifically biological concepts. For example, systems and methods consistent with the present disclosure can be applied to a variety of fields, including, but not limited to, nanotechnology (simulation of micr- and nano-devices), physiological flows (e.g., within a body, including cardiovascular, pulmonary, lymphatic, tissue perfusion, etc.), drug discovery and delivery (including chemical optimization), materials science, catalysis, structure, and reactivity, and energy (fuel cells, ion storage, osmosis, etc.).

The present invention recognizes the complexities of biological systems and processes, particularly within a cellular environment, and provides simulation systems and methods to account for such complexities. In particular, the present invention includes systems and methods for providing multiscale simulations of biological systems and processes that involve a disparate range of spatiotemporal scales, such as those composed of colloidal particles or polymers moving in a fluidic molecular environment.

The systems and methods utilize a multiscale modeling framework to account for dynamics of a structure (e.g., particle, molecule, etc.) with dynamics of a surrounding fluid (e.g., solvent) and the mutual exchange of forces upon one another across various spatial scales. For example, the modeling framework may be based off of one or more digital models having a hierarchical multigrid structure including one or more layers, each layer being representative of the structure and/or fluid at a specific spatial scale. Each layer of the multigrid structure may further be defined by a plurality of individual and independent spatial regions. The systems and methods are configured to account for movement of the structure and/or the fluid in any one of the spatial regions, and, in turn, interconnect layers of the multigrid structure, such that movement at a first layer is synchronized with movement at a second layer in each of the plurality of individual and independent spatial regions, and further interconnect the plurality of individual and independent spatial regions. Based on the interconnections, the systems and methods are configured to generate a multiscale simulation accurately depicting the interplay of the cause-and-effect among a structure and the surrounding fluid, such as a protein molecule within a surrounding solvent in a cell-like environment.

The systems and methods of the present invention are able to address multiscale and multiphysics problems that current modeling and simulation systems fail to address when attempting to simulate biological processes. By accurately accounting for the interplay of the cause-and-effect among a structure and a surrounding fluid, the systems and methods of the present invention allow for simulations of a wide variety of complex biological systems and processes, and thus present numerous fields of application. For example, the present invention can improve drug discovery and development, in that the present invention allows for simulation of biochemical transitions activated by surrounding flows, including unfolding, refolding, allostery, cleavage, and substrate binding, which can allow for the virtual assessment of drug performance before engaging experimental studies, which can be costly and time-consuming. The present invention can further improve the study and treatment of diseases by allowing for the simulation of large-scale biological solutions unveiling molecular recognition, diffusive processes, signaling pathway, diffusion in cell-like environments. Furthermore, the systems and methods of the present invention can be used as a non-invasive diagnostics tool, in that physiological flows in complex conduits (as reconstructed from 3-D or 2-D medical imaging) can be simulated, thereby enabling the characterization of blood streams in cardiovascular and cerebral networks, as well as airflow in nasal and pulmonary air-paths, for example.

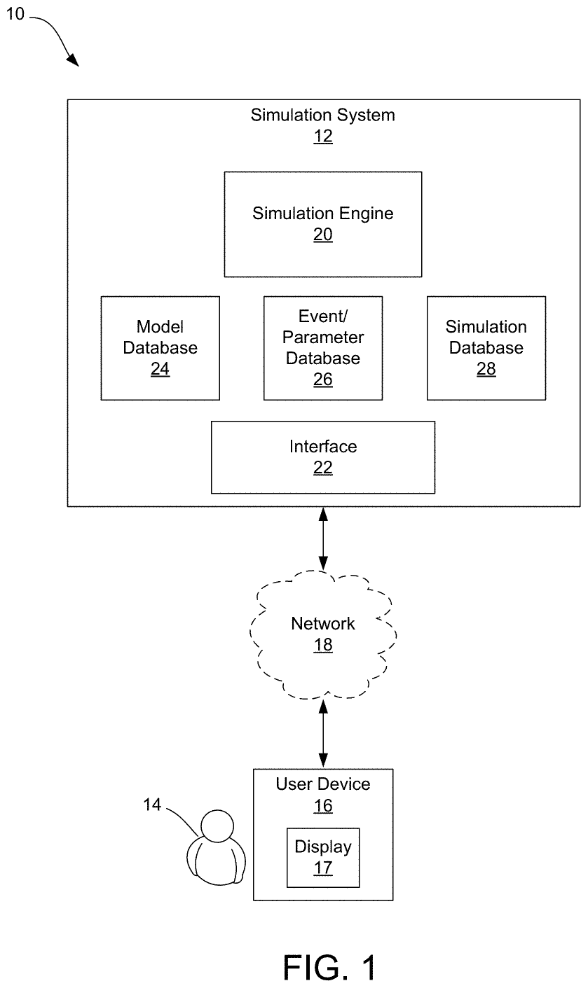

FIG. 1 is a block diagram illustrating one embodiment of an exemplary system 10 for providing a multiscale simulation. As shown, the system 10 includes a simulation system 12 which may be embodied on an internet-based computing system/service, such as a cloud-based server/service, for example, or may be embodied locally on a user device 16. If not provided locally on the user device 16, the simulation system 12 is configured to communicate and share data with a user 14, via the user device 16, over a network 18.

The network 18 may be any network that carries data. Non-limiting examples of suitable networks that may be used as network 18 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), the most recently published versions of IEEE 802.11 transmission protocol standards, other networks capable of carrying data, and combinations thereof. In some embodiments, network 18 is chosen from the internet, at least one wireless network, at least one cellular telephone network, and combinations thereof. As such, the network 18 may include any number of additional devices, such as additional computers, routers, and switches, to facilitate communications. In some embodiments, the network 18 may be or include a single network, and in other embodiments the network 18 may be or include a collection of networks.

For example, the simulation system 12 is configured to communicate and share data with a device associated with one or more users 14 (hereinafter referred to as user device 16). The user device may be embodied as any type of device for communicating with the simulation system 12, and/or other user devices over the network 18. For example, at least one of the user devices may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure.

The simulation system 12 is configured to provide an interface with which the one or more users 14 may interact for the purposes of creating visualizations, specifically visual representations for illustrating a scientific concept generally in the form of computer simulations illustrating a biological concept or process. For example, as shown, the system 12 includes a simulation engine 20 configured to receive input from a user 14, via an interface 22, wherein the simulation engine 20 is configured to generate one or more simulations based on the user input. The interface 22 may be in the form of a web portal or a graphical user interface (GUI). The interface 22 provides a user with the ability to select specific biological systems and/or processes to be simulated. More specifically, the simulation system 12 allows for a user to design, simulate, and model structures within fluids using a collection of individual models and provides users with the option to select certain simulation/interaction modalities that will influence the dynamics of models within a simulation created by the user. As will be described in greater detail herein, the simulation engine 20 is configured to account for the interplay of the cause-and-effect among a structure and a surrounding fluid across a wide and disparate range of spatiotemporal scales (i.e., spatial scales including atomistic, mesoscopic, nanometric, micrometric, metric, and temporal scales including picoseconds, nanoseconds, microseconds, milliseconds, minutes, hours, days, and years).

For example, the simulation system 12 provides a user with the ability to select from a plurality of digital models of structures and digital models of fluids stored in a model database 24. The simulation system 12 further provides a user with the ability to select one or more simulation/interaction events and/or parameters from an event/parameter database 26. The simulation/interaction events and/or parameters will influence the dynamics of models within a simulation created by the user. For example, the event/parameter database 26 may include a plurality of environments, such as pre-programmed biological or cellular environments, that allow the users to simulate and test the interactions of the structures with certain environments, including certain surrounding fluids, either naturally-occurring or synthesized. A user can control, via selection from the event/parameter database 26, certain parameters, such as temperature, salinity, pH, osmolality, and/or viscosity, which, in turn, can influence the dynamics of models in the simulation. For example, a user could utilize the simulation system 12 to design a novel therapeutic protein and model that protein within the context of a cellular membrane which itself has a realistic and accurate composition of lipids and cell-surface proteins. In such an example, the users could select a specific molecular dynamics modality to govern the motions and interactions of the novel therapeutic and the cell surface proteins. Upon receiving the user input, including selections from the model database 24 and the event/parameter database 26, the simulation engine 20 is configured to generate a simulation which can then be stored in a simulation database 28 and further presented to the user, or any other intended recipient, via a display 17. As shown, the display 17 may be included on the user device 16. However, it should be noted that the simulation file can be transmitted to a remote device via any known transmission method, such as email, and then be displayed.

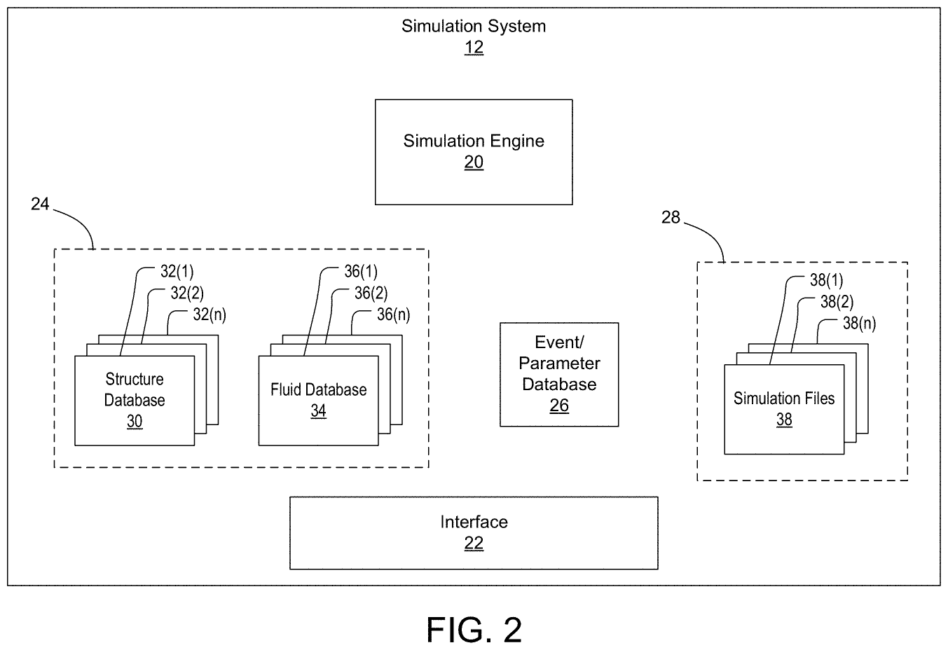

FIG. 2 is a block diagram illustrating the simulation system 12 in greater detail. As previously described, the system 12, specifically the simulation engine 20, is configured to receive user input, via the interface 22, and to further return a simulation based on user input. The user input may include user selection of one or more structures and/or fluids to undergo simulation, as well as user selection of one or more events and/or parameters for influencing movement of the structure and/or fluid during simulation. The simulation engine 20 is configured to create a multiscale simulation using one or more selected models stored in the model database 24. For example, as shown, the model database 24 may include a structure database 30, including a plurality of digital models 32(1)-32(n) stored within, each digital model having data representing a structure. Similarly, the model database 24 may include a fluid database 34, including a plurality of digital models 36(1)-36(n) stored within, each digital model having data representing a fluid.

A used herein, a structure may include a biomolecule or biomaterial that has a shape and is in relatively solid state, although not limited to the solid state. For example, structures may include large macromolecules, including, but not limited to, proteins, carbohydrates, lipids, and nucleic acids, as well as small molecules, such as primary metabolites, secondary metabolites, and natural products. More specifically, the biomolecules may include protein, nucleic acid (RNA or DNA), lipids, carbohydrates, other molecules or macromolecules, a complex of several proteins, a complex of protein with nucleic acid, or any combination thereof including but not limited to these in a complex with small molecule ligands such as drugs, cofactors, metal ions, etc. The structure may further include a collection of biomolecules or biomaterial that forms a larger unit, such as globules, whole cells, tissues, organs, biological system (i.e., circulatory system, respiratory system, nervous system, etc.), and a complete human body. Furthermore, a structure may include a moving boundary, such as a moving wall (e.g., cell membrane, wall of a tissue or vessel, etc.). A fluid may similarly include one or more biomolecules or biomaterials that are in relatively liquid state. For example, fluids may include body fluids or biofluids within the bodies of human subjects, for example. Such body fluids or biofluids may include, but are not limited to, intracellular fluid, extracellular fluid (e.g., intravascular fluid such as blood plasma, interstitial fluid, lymphatic fluid, transcellular fluid, etc.). It should be noted that the fluid may include a single-species fluid or a multi-species fluid, such as a composite solvent. It should further be noted that fluids are not limited to body fluids and may include other fluids not normally found within the human body. It should be noted that the structures and/or fluids may be natural products, or semisynthetic, or totally synthetic.

Each digital model may be understood to refer to a 3D model that is constructed from multiple data sources and includes scientifically accurate structural data, behavioral data, animation data, and structure or fluid dynamics (depending on whether the model corresponds to a structure or a fluid) associated with a structure or a fluid. For example, with regard to animation dynamics, the structure dynamics may be based on Molecular Dynamics modeling, or any other particle-based dynamics modeling. Similarly, the fluid dynamics may be based on Lattice Boltzmann modeling, or any other computational fluid dynamics modeling.

The digital models are built based on scientific information, such as publicly-available data repositories including experimentally-determined data, including structure, dynamics, and the like, for a particle or fluid. For example, a digital model may include raw structural data, such as a set of coordinates from a protein databank (PDB) file, wherein the simulation engine 20 is configured to utilize such raw structural data in a modeling, animation or simulation environment. For example, a PDB file embodies a format for representing actual 3D structures of biological molecules. The PDB format is widely accepted as a standard in the biosciences. The Protein Data Bank currently archives close to 100,000 PDB files of molecular structures, which are freely available to the public. See, e.g., Berman, et al., 2000, The Protein Data Bank, Nucl Acids Res 28(1):235-242.

Additionally, each digital model may be rigged and may also include embedded within all the sources and techniques used in the modeling/rigging activities. A rig is known in the art of 3D animation and generally refers to a 3D construct that provides an organized system of deformers, expressions, and controls applied to a model and that specifies and drives the motion of the model so that it can be effectively animated or simulated. A rig may include joints, bones, particles, springs, or other concepts. Rig has been used in the animation arts to include a deformation engine that specifies how movement of a model should translate into animation of a depicted entity based on the model. A rig provides software and data used to deform or transform a neutral pose of a model into a specific active pose variations. By having animation software manipulate a rig incorporated to a model, animated or simulated movement of the model is achieved. Rigging may sometimes be referred to as character setup or animation setup. Accordingly, the simulation engine 20 may include modeling or animation software such as, for example, AUTODESK MAYA by Autodesk, Inc. (San Rafael, Calif.). It should be noted, however, that any suitable animation software may be used. Exemplary animation software products include those provided by CINEMA4D STUDIO by Maxon Computer Inc. (Newbury Park, Calif.), BLENDER supported by the Stichting Blender Foundation (Amsterdam, the Netherlands), and 3DS MAX 2014 by Autodesk, Inc. (San Rafael, Calif.).

As such, a digital model of a structure (i.e., digital model 32(1)), for example, may include a multi-dimensional (e.g., 3D molecular) model that integrates scientific information (structural, dynamic, and other) that is “ready to use” for visualization. Digital models of structures may be built de novo or by sourcing scientific data from a suitable source such as, for example, a simulation, structural data (e.g., from protein data bank), dynamic data, or the scientific literature. Accordingly, the simulation engine 20 may include a 3D graphics application configured to receive the digital models and generate simulations thereof based, at least in part on, data of each digital model which may specify what pieces of a model were derived from what kind of data (e.g., X-ray vs. NMR vs. cryo-EM vs. modeled de novo using hypothetical data vs. others), the range of motion for a model as captured by one or multiple rigs (remembering that any given protein or other macromolecular model can have multiple rigs associated with it), domains/regions of the model associated with certain known biochemical behaviors, and the like. For example, the model for a transmembrane protein may include, besides the structural data itself such as the shape(s) of the protein and its known range of motion, the transmembrane domain being flagged with metadata such that the protein embeds itself properly into a lipid bilayer when combined with a model or simulation of a lipid bilayer membrane. Another kind of data includes sites of post-translational modifications such as phosphorylation, glycosylation, or others.

Accordingly, the structural data provides that the depicted structure and/or fluid will be scientifically accurate and the behavioral, animation, and/or dynamics data provides scientifically accurate range-of-motion or dynamic information so that the animations will illustrate interactions with desired accuracy. Since the structure and fluid models are stored in a database, the system can use them as-is—that is, the models are “ready for use” in building animations and a user need not manipulate files in order to confer accurate dynamics on the depicted structure or fluid. Selected entries from a model database can be imported into the simulation engine 20 to create animations that may be used, in turn, to create digital media, such as simulation files 38(1)-38(n) to be stored in a simulation database 28.

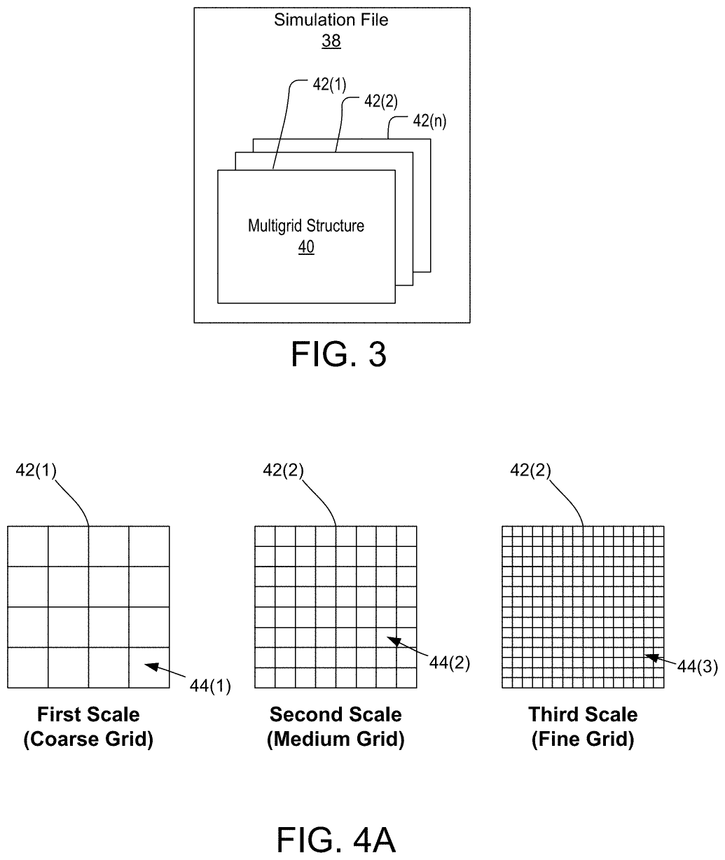

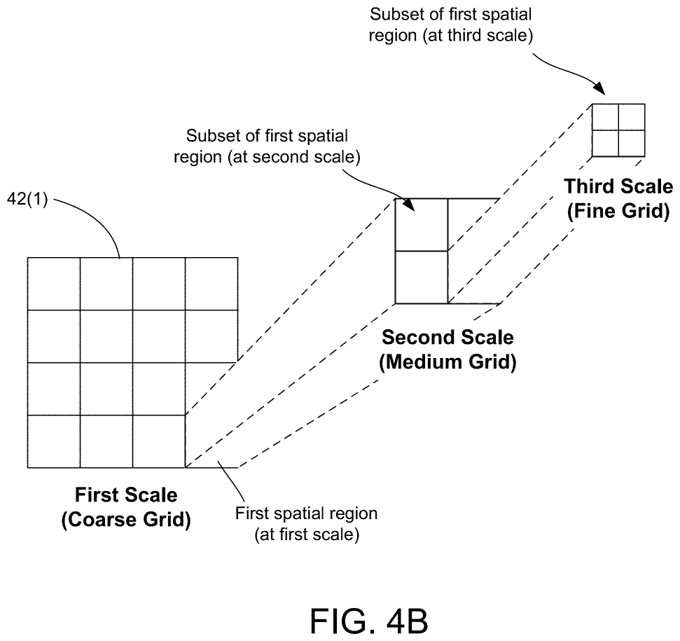

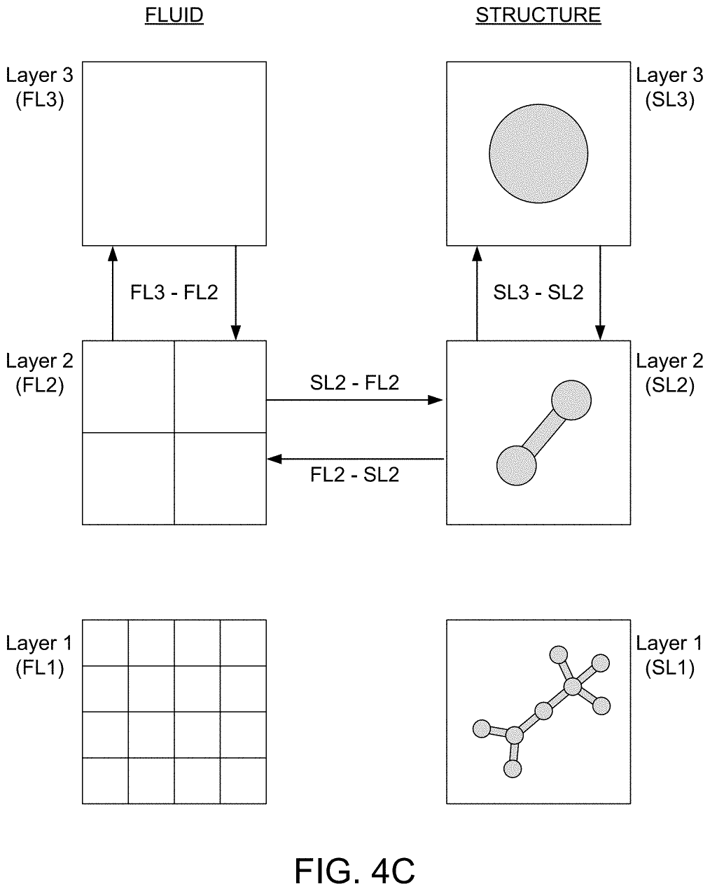

FIG. 3 is a block diagram illustrating a simulation file 38 in greater detail. As previously described, the simulation system 12 utilizes a multiscale modeling framework to account for dynamics of a structure with dynamics of a surrounding fluid and the mutual exchange of forces upon one another across various spatial scales. In order to achieve this, a given simulation file 38 includes a hierarchical multigrid structure 40, which generally consists of one or more layers 42(1)-42(n), each layer being representative of the structure and/or fluid at a specific spatial scale. FIGS. 4A and 4B illustrate a hierarchal multigrid structure 40 of a digital simulation file 38 used in the multiscale modeling framework of the simulation system 12. As shown, each layer 42(1)-42(n) of the multigrid structure 40 generally represents a specific spatial scale (i.e., atomistic, mesoscopic, nanometric, micrometric, metric, etc.). Furthermore, each layer 42(1)-42(n) is defined by a plurality of individual and independent spatial regions 44, wherein each spatial region is generally in the form of a sector within a given layer. For example, as shown in FIGS. 4A and 4B, and by way of example, the multigrid structure 40 of a simulation file 38 may include three layers. However, it should be noted that the multigrid structure 40 may include any number of layers. As shown, a first layer 42(1) of the multigrid structure 40 may represent a first scale (i.e., micrometric scale) and have a first set of a plurality of individual and independent spatial regions 44(1) defining a course grid pattern, a second layer 42(2) of the of the multigrid structure 40 may represent a second scale (i.e., nanometric scale) and have a second set of a plurality of individual and independent spatial regions 44(2) defining a medium grid pattern, and a third layer 42(3) of the of the multigrid structure 40 may represent a third scale (i.e., atomistic scale) and have a third set of a plurality of individual and independent spatial regions 44(3) defining a fine grid pattern. As illustrated in FIG. 4B, an individual spatial region of the first layer 42(1) may be split into a set of spatial regions when traversing between layers, as represented in the medium and fine grid patterns of the second and third layers 42(2) and 42(3). For example, the individual spatial region of the first layer 42(1) may be split into a set of individual spatial regions (i.e., 2 by 2 spatial region pattern) in the second layer 42(2), which, as a whole, represents the individual spatial region of the first layer 42(1). Similarly, any one of the individual spatial regions from the set in the second layer 42(2) may further be split into another set of individual spatial regions (i.e., 2 by 2 spatial region pattern) in the third layer 42(3). Accordingly, as the spatial scale moves from a larger scale to smaller scale (i.e., from a metric scale in the first layer 42(1) to an atomistic scale in the third layer 42(3)), an individual spatial region from a layer at a larger spatial scale is generally split into a corresponding set of smaller individual spatial regions at a layer at a smaller spatial scale.

The simulation engine 20 is configured to utilize the multiscale modeling framework in order to account for the dynamics of a structure (e.g., particle, molecule, etc.) with the dynamics of a surrounding fluid (e.g., solvent) and the mutual exchange of forces upon one another across the various spatial scales. For example, each layer 42 of the multigrid structure 40 of a simulation file 38 may be representative of a structure and/or a fluid at a specific spatial scale. Because each layer 42 of the multigrid structure 40 is defined by a plurality of individual and independent spatial regions 44, the simulation engine 20 is configured to account for movement of the structure and/or the fluid in any one of the spatial regions 44, and, in turn, interconnect layers 42 of the multigrid structure 40, which allows for synchronizing movement of the structure and/or the fluid between layers to allow for scale coupling and subsequent generation of a multiscale simulation.

For example, FIG. 4C illustrates multiple layers of a multigrid structure of a simulation file, further illustrating the plurality of individual and independent spatial regions at each layer and the interconnecting of layers of the multigrid structure. In the illustrated embodiment, the multigrid structure may include three layers are three different spatial scales, similar to the examples in FIGS. 4A and 4B. As shown, both a structure and a fluid are defined in an individual and independent spatial region at each of the three layers. The simulation engine 20 may include custom, proprietary, known and/or after-developed statistical analysis code (or instruction sets), hardware, and/or firmware that are generally well-defined and operable to receive two or more sets of data and identify, at least to a certain extent, a level of correlation and thereby associate the sets of data with one another based on the level of correlation. For example, the simulation engine 20 is configured to interconnect two or more of the layers so that movement of the structure and/or the fluid at a first layer is synchronized with movement at a second layer in each of the plurality of individual and independent spatial regions. For example, as shown, a structure (i.e., biomolecule) is defined in spatial regions across three layers (layers 1-3) of a multigrid structure at three different spatial scales (layer 1 of a larger scale and layers 2 and 3 of increasingly smaller scales). The simulation engine 20 is configured to interconnect layers 2 and 3 with one another (Structure Layer 2 (SL2) with Structure Layer 3 (SL3)) to thereby synchronize movement of the structure in layer 2 with movement of the structure in layer 3. Similarly, a fluid (i.e., solvent) is defined in the spatial regions across the three layers (layers 1-3) of the multigrid structure. The simulation engine 20 is configured to interconnect layers 2 and 3 with one another to thereby synchronize movement of the fluid in layer 2 with movement of the structure in layer 3 (Fluid Layer 2 (FL2) with Fluid Layer 3 (FL3)). Furthermore, the simulation engine is configured to account for interplay between structure dynamics and fluid dynamics within the same spatial regions (i.e., SL2 and FL2 influence on structure movement and FL2 and SL2 influence on fluid movement). In particular, the simulation engine 20 is configured to account for interplay between the structure dynamics and the fluid dynamics, wherein the interplay is based on the structure exerting a density of field upon the fluid proportional to a gradient and the fluid exerting a density of field upon the structure proportional to the gradient.

The simulation engine 20 is further configured to interconnect the plurality of individual and independent spatial regions, such that a multiscale simulation of the structure and fluid can be generated, which accurately depicts the interplay of the cause-and-effect among a structure and the surrounding fluid, such as a protein molecule within a surrounding solvent in a cell-like environment, across multiple spatiotemporal scales.

The systems and methods of the present invention are able to address multiscale and multiphysics problems that current modeling and simulation systems fail to address when attempting to simulate biological processes. By accurately accounting for the interplay of the cause-and-effect among a structure and a surrounding fluid, the systems and methods of the present invention allow for simulations of a wide variety of complex biological systems and processes, and thus present numerous fields of application.

For example, the present invention can improve drug discovery and development, in that the present invention allows for simulation of biochemical transitions activated by surrounding flows, including unfolding, refolding, allostery, cleavage, and substrate binding, which can allow for the virtual assessment of drug performance before engaging experimental studies, which can be costly and time-consuming. The present invention can further improve the study and treatment of diseases by allowing for the simulation of large-scale biological solutions unveiling molecular recognition, diffusive processes, signaling pathway, diffusion in cell-like environments. Furthermore, the systems and methods of the present invention can be used as a non-invasive diagnostics tool, in that physiological flows in complex conduits (as reconstructed from 3-D or 2-D medical imaging) can be simulated, thereby enabling the characterization of blood streams in cardiovascular and cerebral networks, as well as airflow in nasal and pulmonary air-paths, for example.

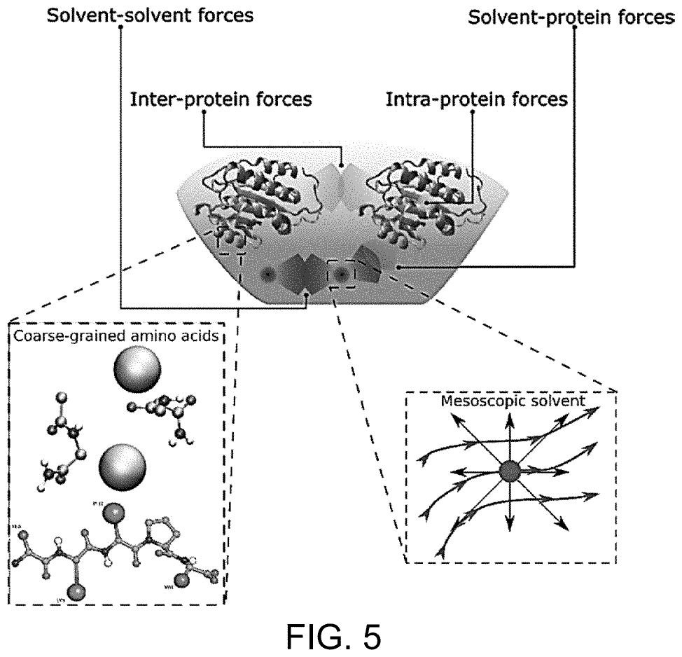

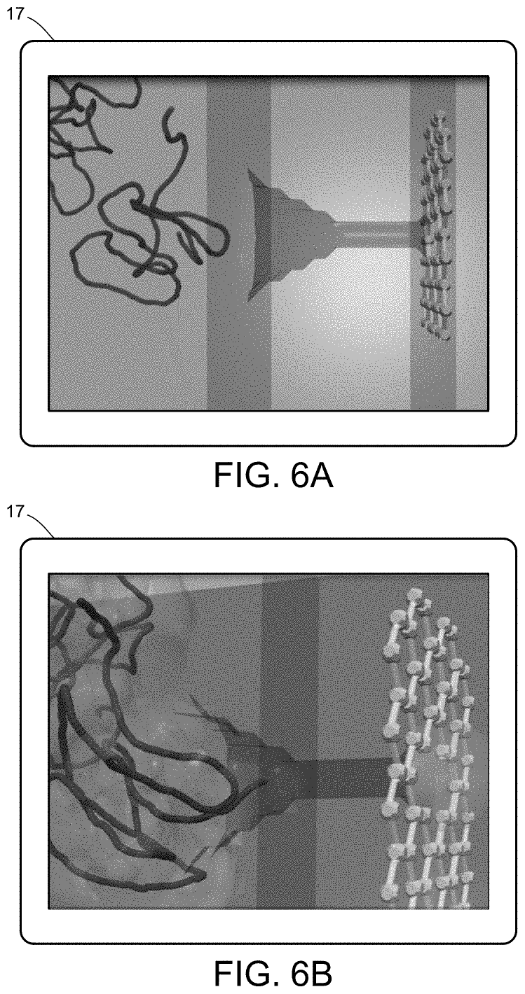

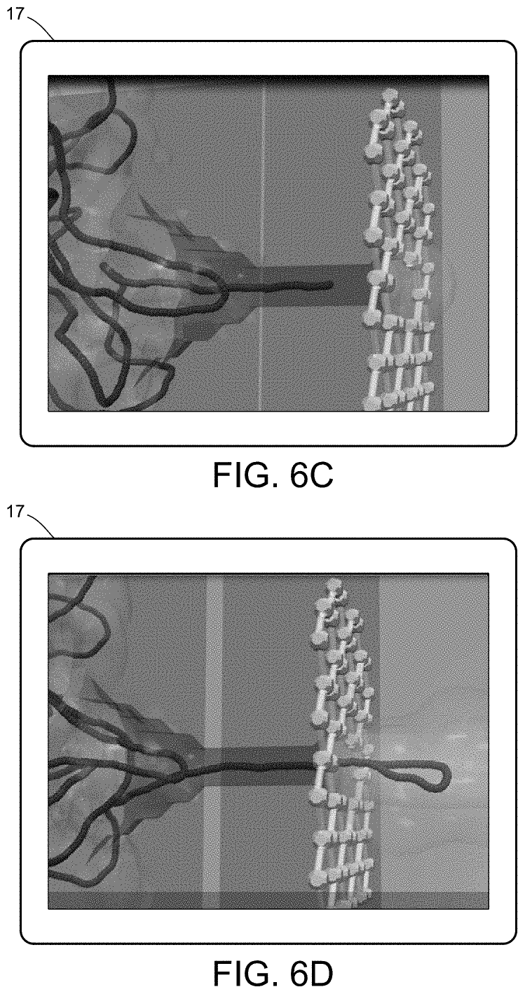

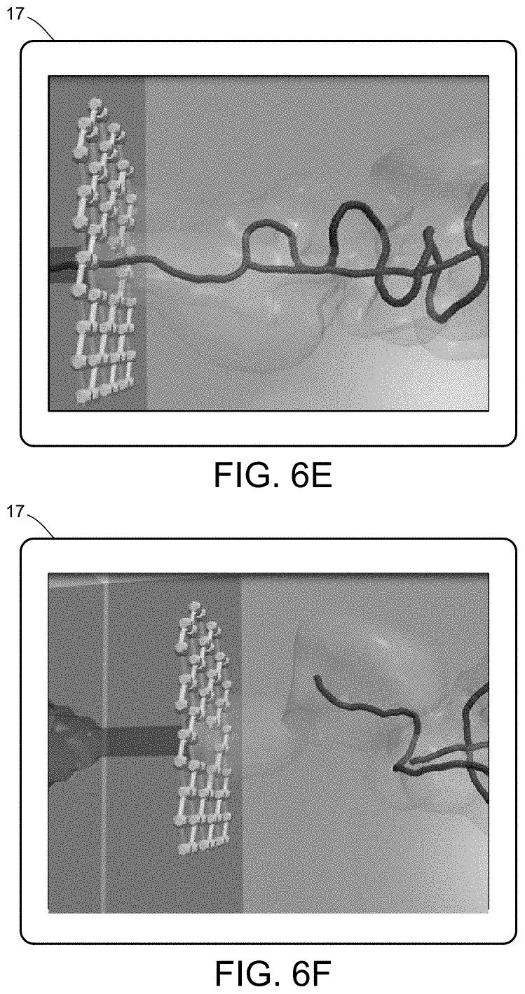

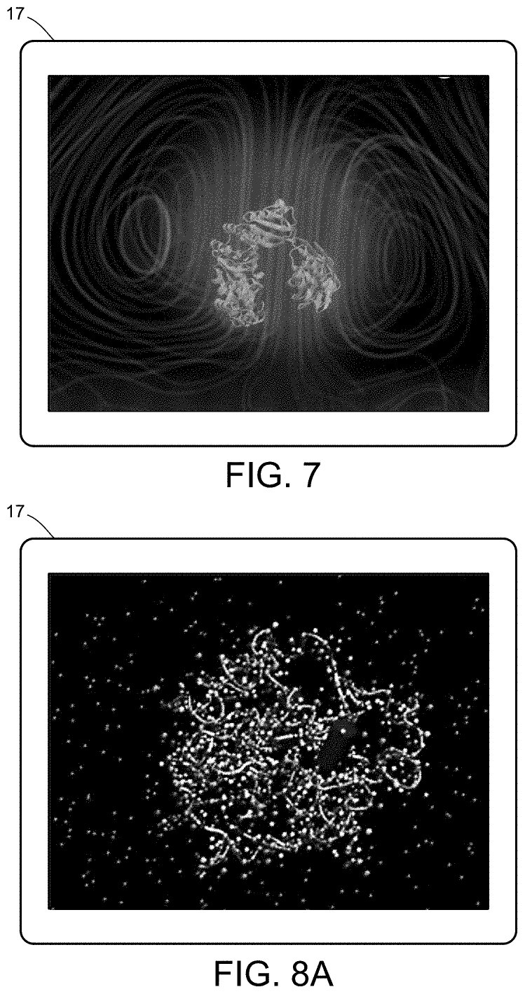

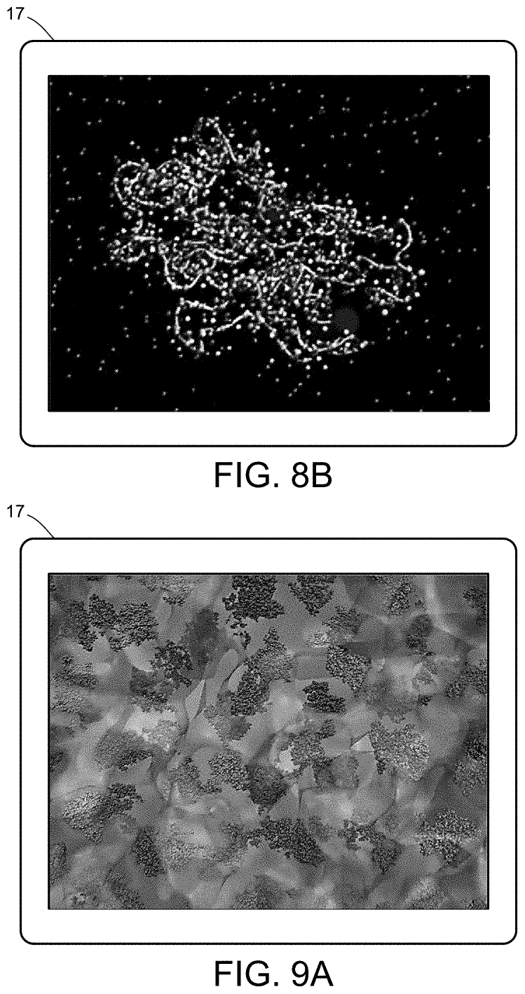

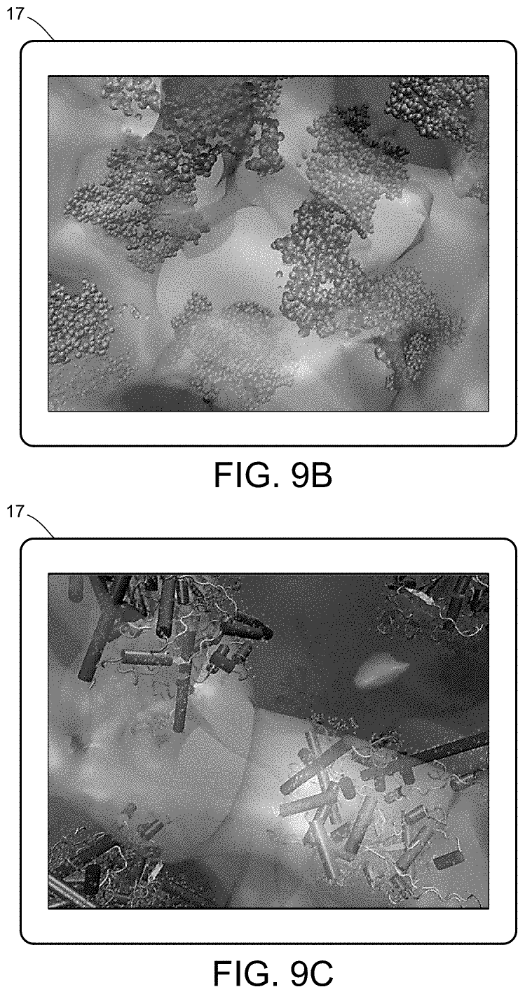

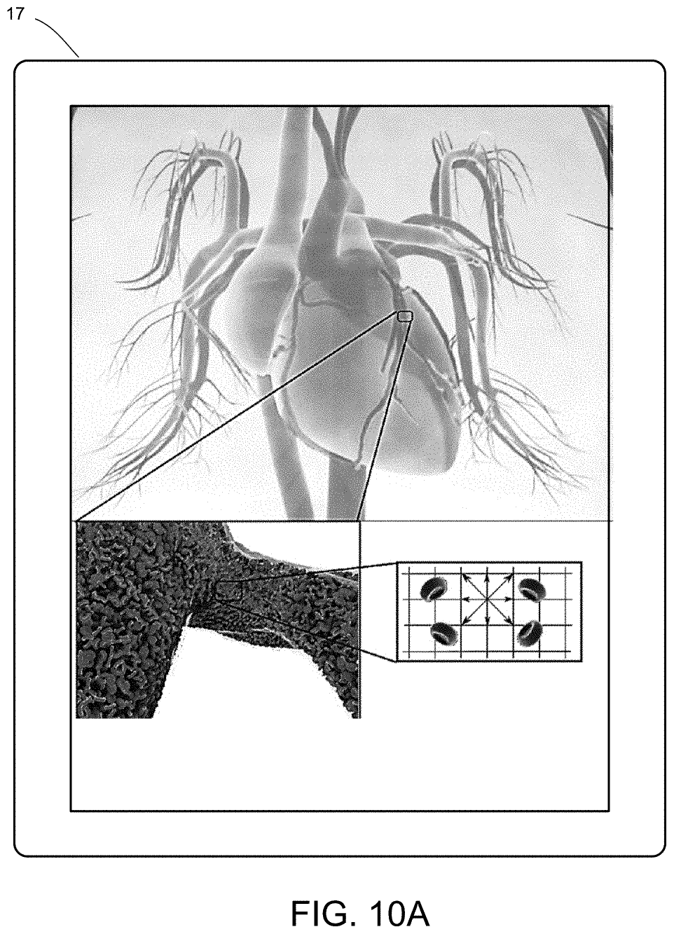

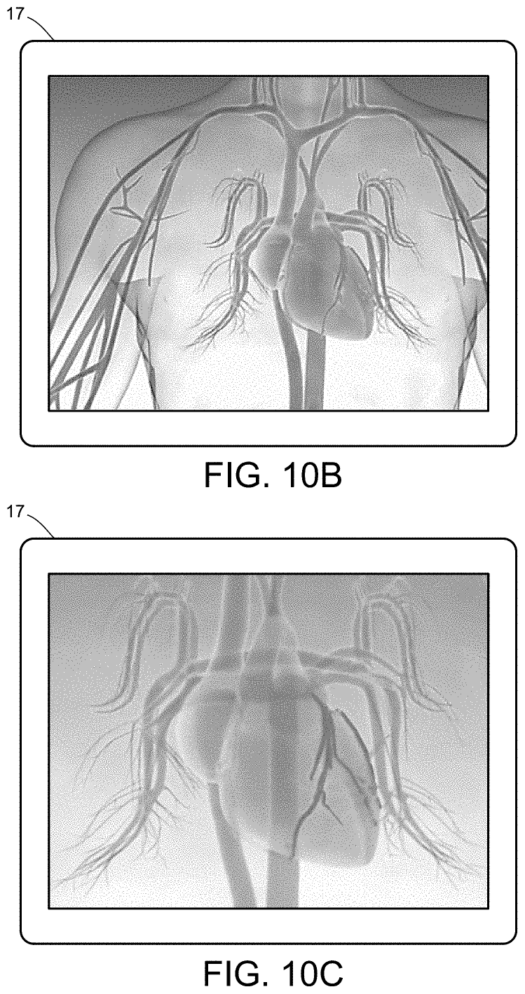

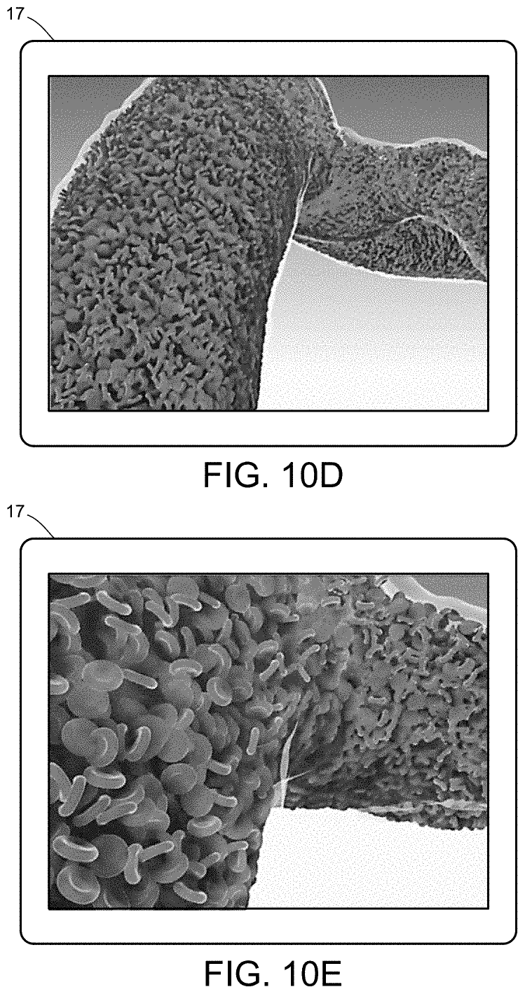

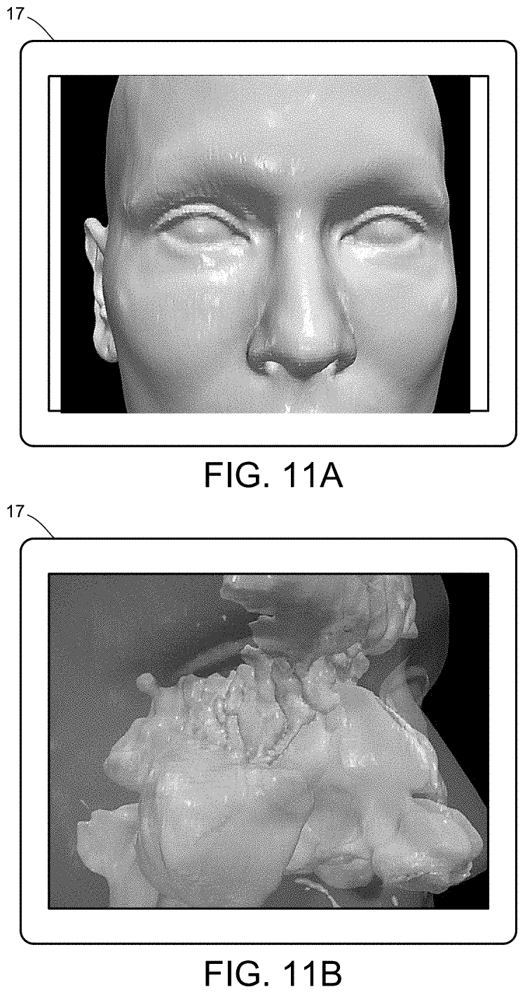

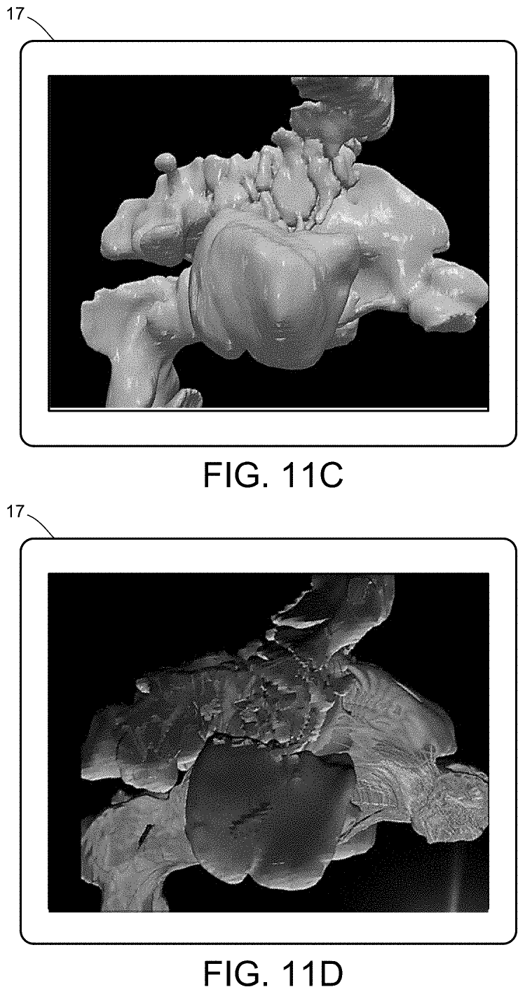

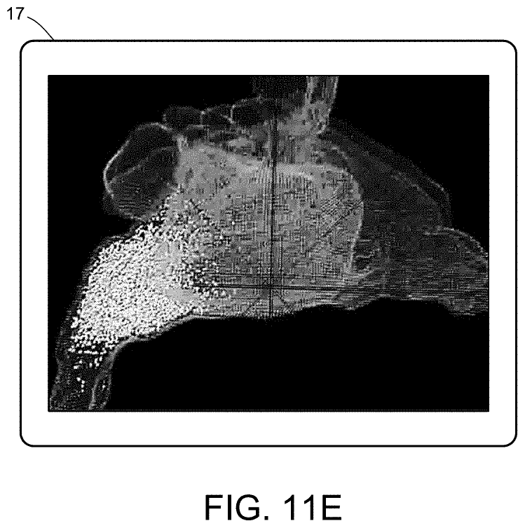

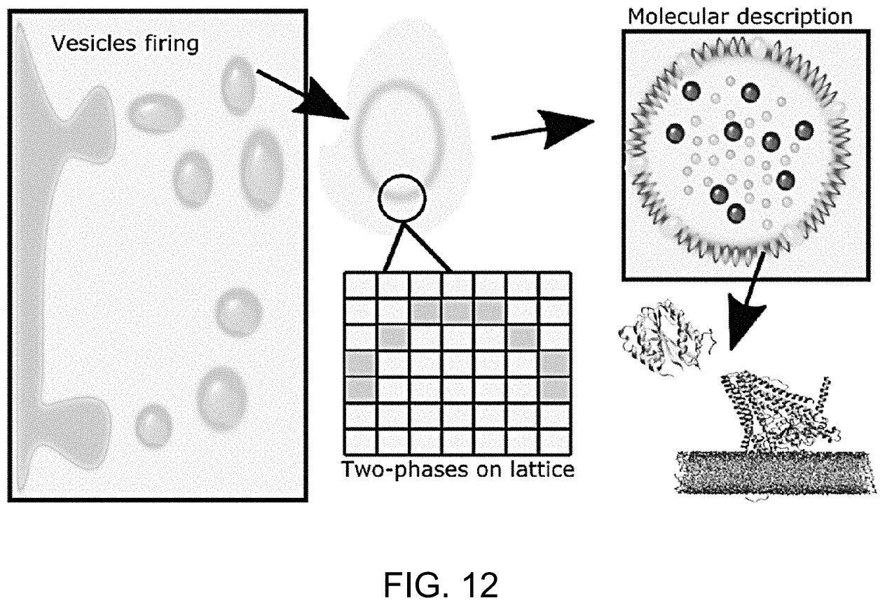

FIGS. 5-12 illustrate numerous fields of application to which the systems and methods of the present invention can be applied. For example, FIG. 5 illustrates an exemplary composition containing proteins within a solvent, illustrating the different forces that must be accounted for in order to provide an accurate simulation of protein and/or fluid movement based on the interplay of the cause-and-effect among the protein molecules and the surrounding solvent across different spatial scales. FIGS. 6A-6F illustrate a multiscale simulation of molecular nanotranslocation. FIG. 7 illustrates a multiscale simulation of vesicular firing. FIGS. 8A and 8B illustrate a multiscale simulation of flow-activated protein transitions in blood coagulation. FIGS. 9A-9C illustrate a multiscale simulation of quantitative enzymatic characterization. FIGS. 10A-10E illustrate a multiscale simulation of red blood cells and plasma in 3D scanned coronary arteries. FIGS. 11A-11D illustrate a multiscale simulation of airflow within a nasal cavity in 3D scanned respiratory tracts. FIG. 11E illustrates a multiscale simulation of diffusion of olfactory tracers within a nasal cavity in 3D scanned respiratory tracts. FIG. 12 illustrates a multiscale representation of vesicles transporting proteins.

As previously described, the multiscale modeling framework provided by the systems and methods of the present disclosure account for the dynamics of a structure (e.g., particle, molecule, etc.) with dynamics of a surrounding fluid (e.g., solvent) and the mutual exchange of forces upon one another across various spatial scales. The structure dynamics (or particle dynamics) may generally be based on Molecular Dynamics (MD) modeling and the fluid dynamics may generally be based on Lattice Boltzmann modeling.

Lattice Boltzmann methods (LBM) (or thermal lattice Boltzmann methods (TLBM)) are a class of computational fluid dynamics (CFD) methods for fluid simulation. Instead of solving the Navier-Stokes (NS) equations, the discrete Boltzmann equation is solved to simulate the flow of a Newtonian fluid with collision models such as Bhatnagar-Gross-Krook (BGK). By simulating streaming and collision processes across a limited number of particles, the intrinsic particle interactions evince a microcosm of viscous flow behavior applicable across the greater mass.

LBM can be used for complex fluid systems. Unlike the traditional CFD methods, which solve the conservation equations of macroscopic properties (i.e., mass, momentum, and energy) numerically, LBM models the fluid consisting of fictive particles, and such particles perform consecutive propagation and collision processes over a discrete lattice mesh. Due to its particulate nature and local dynamics, LBM has several advantages over other conventional CFD methods, especially in dealing with complex boundaries, incorporating microscopic interactions, and parallelization of the algorithm. A different interpretation of the lattice Boltzmann equation is that of a discrete-velocity Boltzmann equation. The numerical methods of solution of the system of partial differential equations then give rise to a discrete map, which can be interpreted as the propagation and collision of fictitious particles.

The multiphase LB schemes discussed in the previous Section have generated a mainstream of applications in soft matter research, since they permit to deal with ows of great dynamic and morphological complexity, such as foams and emulsions. However, they are unsuited to handle rigid bodies suspended in the continuum phase, nor can they describe in detail mechanical properties of deformable objects, say membranes, vesicles, cells and other biological bodies. To that purpose, the LB method needs to be explicitly coupled with particle methods tracking to the dynamics of the biological bodies immersed in the flow. Indeed, most flows of biological interest consist of biological bodies of assorted nature: cells, polymers, and/or proteins floating in a fluid solvent, typically water. Such flows often operate at low, often near-zero, Reynolds number, but this does not mean that hydrodynamic interactions (HI) can be neglected. To the contrary, HI have repeatedly been shown to accelerate a variety of nanoscale biological transport processes, such as biopolymer translocation across nanopores, amyloid aggregation of proteins in the cell and other related phenomena. Accordingly, the combination of LB with particle dynamics provides for such a comprehensive multiscale simulation scheme.

The combination of LB modeling and MD modeling to provide for the multiscale simulations of the present disclosure provide the potential of simulations in areas straddling across physics, chemistry, and biology (PCB). The following selected detailed examples provide a sampling of the breadth of applications that the systems and methods can provide. Clearly, the PCB interface is enormously rich and varied, ranging from nanometric macromolecular phenomena, to peptidic aggregation and biopolymer translocation, to cellular motion and active matter.

One example of a particularly complex PCB system and/or process relates to bipolymer translocation, such as shown in FIGS. 6A-6F. The translocation of biopolymers, in particular DNA or RNA strands, in nanometric pores provides a showcase of the synergistic hydrodynamic effects assisting or interfering with the translocation process. The translocation mimics a genuinely biological one, whereby viral penetration takes place via the injection of viral genetic material into the host cell's cytoplasm. At technological level, understanding how the physics of nanopores controls translocation inspires new paths to fast DNA sequencing. Nanopores-based technologies ultimately aims at translocating polynucleotidic chains through a nanoconfined environment, where the genetic information can be decoded by optical mapping, ionic or electronic detection. The challenge is to control the process and the random, squiggly forms that the polynucleotide takes in solution, eventually designing nanofuidic devices according to stringent photolithographic requirements.

Computer simulations based on the systems and methods of the present disclosure have the ability to access the fine details of the translocation process, both for technological innovations and for a better understanding of the biological processes involving the migration of small biopolymers.

Biopolymer translocation has been analyzed in different set-ups and modeling details for the translocating biopolymer, starting by a single necklace and neutral polymer threading between two chambers driven by a localized force acting only within the pore region (bead pulling). This set-up mimicked real experiments where, given the presence of two electrodes at large distance from the pore, the electric field is overly intense where resistance is higher and mostly constant inside the pore region. In addition, electrostatic interactions stemming from the charged polymer are modelled in terms of effective beads of the chain. Simulations of translocation in small pores have thus focused on the dependence of the translocation time on the polymer length, thereby showing that the effect of hydrodynamic interactions is best seen on the translocation time vs chain length with the characteristic exponent being 1:27 for short and 1:32 for long polymer chains, a result that is explained in terms of scaling analysis and energetic considerations, that are peculiar to such hydrodynamic-assisted process. Translocation in large pores showed an even richer phenomenology, with the appearance of several different configurations of the polymer folds, the consequence of fast translocation events that create discrete states that reflect on quantized current blockades on the measurable ionic currents. Even more central is the role of electrokinetic forces on the process, the physical ingredient that can be included only by the full solution of the charged polymer whose translocation is driven by the self-consistent electric field. Even by including the double helix structure of polynucleotides, the complexity of the numerical apparatus can be optimally handled within the coherent LB and MD framework, complemented by the solution of the Poisson equation for electrostatics. The result is a detailed description of translocation and the measure of the ionic currents, locally modulated by the threading polymer and being the result of the concurrent effects of excluded volume, drag and electrostatic forces. Importantly, the development of new coarse-grained potentials for DNA and RNA paves the way to reveal the effect of the strong charging of the nucleic backbone that could not be elicited by using more aggressive coarse-grained models.

The set-up of translocation consists of two large chambers, a cis and a trans chamber, containing the pretranslocating and post-translocated portions of the DNA strand. The chambers are typically much larger than the nanopore characteristic size. Translocating a long DNA or RNA chain into extremely narrow pores results in large entropy loss caused by the confinement and the need to stretch the macromolecule. The associated free-energy barrier reduces the biopolymer capture rates and causes clogging at the nanochannel/pore entrance. On the other hand, solvent-assisted interactions lubricate the process. It is key to understand that the hydrodynamics of the translocating biopolymer in such fluidic device, being modulated by competing forces acting in the chambers and in the pore, give rise to a genuine multiscale scenario. When facing such complex set-up, all-atoms MD methods, or even coarse-grained representations of the translocating biopolymer, neglect the explicit representation of the solvent, thus imposing severe limitations to the overall accuracy. Resorting to strategies based on a direct solution of the NS equations, or using other mesoscopic numerical methods (Lagrangian or Eulerian based) is challenging in terms of generating consistent fluctuations under confinement and achieving a stable numerical method. In this respect, the LB-MD method is attractive because it allows generating the thermal fluctuations in a natural way and guarantees numerical stability over a wide range of translocation rates. In addition, one can analyze biomolecules of different size and initial configurations, in situations where the biomolecule is approaching the pore or is already in a docked configuration. LB and PD has been utilized to analyze multiple scenarios when the biopolymer has lateral size comparable or smaller than the pore diameter, conditions giving rise to single or multiple translocation configurations.

When accounting for the simultaneous presence of hydrodynamic and frictional forces, one can initially rely on the assumption of charge neutrality for the biopolymer and saline solution, a simplification justified by the need to reduce the computational effort. However, electrostatics is essential to guide the ionic currents and the current blockades caused by the impeding DNA molecule. A direct understanding of the ionic current blockades provides a stringent comparison with experimental measurements. The situation is even more complicated under ow conditions, whereby the interplay between electrostatics and flow does not allow to utilize simplified solutions based on the assumption of global or local equilibrium. The inclusion of electrokinetics, that is, the representation of the multi-component saline solution that flows together with DNA from chamber to chamber, provides a direct access to the electrohydrodynamic process.

As anticipated, electrohydrodynamics is a fundamental aspect of the biological function, in particular as regarding to ion channels, the prototypical example of nanoscopic pores that subtend to the passage of ions in and out of the cell and regulate its volume. Ion channels are found within the membrane of most cells and are basically proteins that form the pore connecting the inner and outer parts of the cell. They look as narrow, water-filled pores that allow ions of certain types to pass through via selective permeability, privileging specific species, typically sodium or potassium. The transport of monovalent or divalent species depends crucially on the morphological properties of the confining elements that decorate the pore, notably charged peptidic groups that form the inner scaffold of the channel.

Knowledge of the way that ionic transfer takes place unveils the biological functioning. However, simulating a large biological aggregate composed of a membrane, ion channel, and the inner and outer sides of the cell, comprises a number of degrees of freedom, easily in excess of millions. As a result, a large spread of relevant timescales exists, which is often inaccessible to today's computers. In principle, an alternative route is to leverage the statistical-mechanical approach such that the atomistic representation of the pore proteins is substituted by higher-level, coarse-grained descriptions. Another pillar of kinetic modeling, the Nernst-Planck equation, makes drastic simplifications by neglecting hydrodynamics altogether, but provides the fluxes of ionic species as a function of the concentration and applied voltage. Such drastic simplification misses the fine details of ionic transport and the imperfect screening occurring inside the narrow cavities of the ion channel. From the operational standpoint, studying ionic transport requires matching the atom-based with the continuum-based description, a computationally unviable route due to the huge space/time gap separating the two levels.

As to translocating DNA, an optimal strategy is to proceed along the tandem LB-MD path, whereby any feature that takes place at the fine atomic scale can surface up at the largest available scale, with its full content of longrange and unscreened electrokinetics. The numerical approach grants access to the characteristic ionic response by combining the fluid dynamics of multiple species in solution, the interplay of electrostatics and viscous forces, together with chemical specificity for the confining protein. The latter is particularly effective in determining the fine features within the pore lumen and vestibules that are responsible for ionic selectivity.

Another intriguing aspect of ion channels functioning is the fact that transport takes place under strictly microscopic confinement, whereby the competition among diffusive, stochastic and migration forces together with the channel walls act as an effective thermalizing bath for the moving ions.

Ion channels have provided a stringent benchmark to quantify how local details arising from the channel geometry and the surface charge, the salinity of the electrolytic solution and the physical scale under study, are important to ionic transport and to the ensuing biological function. Electrokinetic forces have been shown to be highly modulated by geometrical details and by the channel surface charge. The presence of internal vestibules of the biological channel, for example, are easily modelled in simulation and provide a direct inspection on how the electric field focuses along the channel axis and thereby modifies channel activity. The role of axial asymmetries can be probed directly. Assimilating the channel shape to a conical one revealed the peculiar characteristic curves where currents are highly rectified by rather small asymmetries in shape. Similarly, the presence of entrance effects at the channel inlet are crucial to capture ions from the bulk and convey them under confinement by de facto lowering the involved energy barriers. The effect of millimolar concentrations of electrolytes has been studied in terms of the double layer theory and unveiled the role of screening on confined transport. Finally, and possibly most importantly, the role of nanoscale forces stemming from excluded volume interactions acting among solvent molecules and ions, provide the critical ingredient to understand how transport under strong confinement takes place.

However, the effort may not be needed to understand the ionic currents semi-quantitatively. In fact, under confinement, hydrodynamics and long-range coherent motion of the aqueous solution dissipate away, due to the channel wall. Therefore, the continuum picture of fluid flow is not the most effective way to represent the ion channel or the entire embedding membrane in 3D. Alternatively, the Fokker-Planck equation describes well the action of the thermalizing channel wall. The mandate is then to cast the Fokker-Planck equation within the LB methodology, a task that has been successfully undertaken. The lattice Fokker-Planck methodology shows the same levels of accuracy, robustness and scalability of the fluid dynamic LB equation.

The LB can be comfortably extended to a broad variety of kinetic equations and one more proof comes from handling excluded volume interactions. The atomic correlations stemming from both electrostatics and excluded volume interactions are particularly intense under the channels operating conditions. Modeling correlations is a crucial element that other methodologies, such as the Nernst-Planck or Dynamical Density Functional Theory, cannot provide in conjunction with the solution of the NS dynamics.

The LB applied to ion channels has found various applications but most of them neglect the role of excluded volume and local specificity. Excluded volume forces acting between molecules can be determined starting from the Enskog collisional kernels, a revised version of kinetic theory of gases, by resolving the ballistics of hard core collisions. The LB scheme accommodates this new collisional kernel in a natural way, another example of the versatility of the LB framework.

Other examples of complex PCB systems and/or processes that the systems and methods of the present disclosure are able to provide multiscale simulations thereof include protein diffusion and amyloid aggregation.

Mesoscopic simulations of macromolecules in aqueous solvent not only allow to account for nanometric-scale hydrodynamics, but also for macromolecular interactions, that are of paramount importance to avoid misfolding and molecular recognition. An important question is the extent to which molecular details are sufficient to reach the required level of biological realism. The answer is definitely problem-specific: representing a protein, a DNA chain or a lipidic chain, may require different degrees of chemical specificity, depending on the research target in point.

It is also legitimate, however, to utilize coarse-grained force fields in a rather flexible way, as long as the mesoscopic properties, fixed at the nanometer/nanosecond scale, are reproduced.

To answer the question about the optimal scale to represent a given biological solutions, this is where kinetic modeling, particularly for the liquid state solution, and the force fields match in accuracy.

At larger scales, micrometers and above, such level of detail may become irrelevant, therefore a fair representation for thermodynamics, possibly via an equation of state, and an accurate representation of fluid mechanics, may fulfill most practical needs. The scenario should also cope with the possible action of long-range forces, especially of electrostatic origin. Fortunately, cellular conditions are such that in bulk conditions and away from the compartment boundaries, screening acts as a powerful localizer of interactions, that die off at distances above few nanometers.

In order to integrate the protein force-fields with the physico-chemical features of solvation, the LB framework should also be enriched with water-like features, inclusive of directional interactions, and hydrogen-bond features, having deep implications on the macromolecular structures. Preliminary efforts in this direction have been made in the past, but their thorough validation remains entirely open.

Many applications of a more water-specific methodology naturally suggest themselves: thermal stability of proteins, the onset of neurodegenerative diseases due to peptidic aggregation, diffusion of proteins and trafficking in cellular crowding, being just some examples in point.

The aggregation of misfolded soluble proteins into fibrils is the precursor of several neurodegenerative diseases, such as the Alzheimer, Parkinson, and Huntington ones. In particular, Alzheimer's disease is marked by atrophy of cerebral cortex showing accumulation of amyloid plaques and numerous neurofibrillary tangles made of filaments of the phosphorylated tau proteins. The major constituents of plaques are made of the amyloid beta peptides made of 40 and 42 amino acids.

The fibrillogenesis of amyloid beta peptides is a complex process whereby fibrils extend up to hundreds of nanometers, and the time scale of full growth exceeds hours in vitro. The details of the emergence of amyloid protofilaments are still debated but it has been observed that the formation of ordered arrays of hydrogen bonds drives the formation of beta-sheets within aggregates that form early under the effect of hydrophobic forces. Understanding the mechanisms of amyloid aggregation is key to the design of drugs able to prevent fibril formation and toxicity in the brain and computer simulation is an essential tool to explore the aggregation process. First and foremost, describing the kinetics of amyloid formation via conventional nucleation theory lacks information on the structure and size of the primary nucleus.

Mimicking amyloid aggregation cannot be done by implicit solvent models, since the lack of solvent interactions does not include the treatment of solvation thermodynamics and neglects altogether the action of solvent-mediated correlations. Self-assembly initiates via a hydrophobic collapse and the formation of molten oligomers, with the common feature of fibrils being the inter-digitation of the side-chains, the so-called steric zipper. Since fibril formation is under kinetic and not thermodynamic control, this is a great showcase for the LB-MD strategy.

Large-scale aggregates would only form with the correct kinetics and showing up the correct intermediate and metastable states by using the highest level of physical fidelity. If a simplifying assumption on the dynamics, such those provided by Langevin level, is used, spurious intermediate states would eventually kick-in, as long as the final aggregate is kinetically driven.

By including hydrodynamic interactions and by employing the OPEP force field, the LB-MD methodology has shown that the solvent mediated interactions have a key role in regulating amyloid aggregation. As a matter of fact, hydrodynamics enhances peptidic mobility, thus facilitating mutual encounters and collapse to the aggregated structure. This should be appreciated in view of the non-trivial computational effort required to simulate the aggregation process, which is not only driven by diffusion but also featuring a slow-down due to the energetic barriers involved in the process.

Physiological flows offer one of the most attractive applications of the LB framework to real-life situations, with high potential social impact in utilizing computer simulations to diagnose pathologies, prognose a medical condition, or even guiding clinical intervention

In the age of evidence-based medicine, the decision-making process needs to be optimized by using evidence from well-designed and well-conducted research. Although all medicine has some degree of empirical support, the evidence based approach requires that only the strongest data coming from meta-analyses, systematic reviews, and randomized controlled trials can be used to inform clinical recommendations.

Physiological flows, for instance, are conditions where a biofluid circulates in complex anatomical conduits and networks, examples ranging from blood ow to lymphatic circulation, to airways, the urinary system and so on. Blood ow has made the subject of intense research over the last decades, the application of LB to blood flows experienced a major burst of activity, with several applications to coronary, carotid and cerebral blood flow. Of course, this is no surprise, since these are macroscale applications for which the most conventional NS hydrodynamics appears perfectly adequate.

It is to be stressed that statistical averaging is of little meaning in a physiological context, since each individual is a story of her/his own. Rather, the detailed access to the patient-specific 4D hemodynamic data across scales of motion, may offer a quantum leap in the quality and accuracy of pre-emptive medicine.

This is why a fully 4D (three-space dimensions and time) real-time numerical and visual access at the blood dynamic flow patterns from microns all the way up to the full-scale geometry, can disclose unprecedented opportunities for personalized and precision medicine, as illustrated in FIGS. 10A-10E.

LB simulations of physiological conduits offer an exciting opportunity due to its most practical asset: simplicity in handling complex geometries and in automated mesh-generation. To the best of our knowledge, such simplicity remains unparalleled as compared to grid methods for the numerical solution of NS equations. Another strength of LB comes from its local structure in space and time. As typical in the study of unsteady flows, the flow patterns are particularly rich and accurate once unsteadiness is taken into account, as for the study of gas flows. Hemodynamics also sets a case, due to the large excursions of local Reynolds number (going from virtually zero in microcapillaries to nearly 10; 000 in the aorta), whereby unsteadiness promotes both local and global patterns. Most importantly, blood is pumped into the vessels by a pulsatile injection rate, a situation that requires time-explicit boundary conditions. In biomechanics, the ratio of transient inertial to viscous forces, the Womersely number, can range from 10⁻³ in capillaries to 10 in the aorta, calling for the direct time-explicit solution in the most general case. The applications are widespread, but it is worth recalling the study of coronary and carotid arteries, as critical vessels that subtend to the oxygenation of the heart muscle or the brain. Any anomaly in the blood ow would cause major risks of heart attack or stroke to the patient. In such networks of arteries, geometric complexity is highly non-trivial; particularly challenging is the handling of conditions where narrowings and plaques give rise eccentric passages and tiny spaces, at times as large as a handful of red blood cells.

The manner in which pressure is distributed in arteries has great physiological relevance, since the supply and demand of oxygen in organs, primarily the heart muscle, is regulated by the distribution of pressure in vessels. It is well known that narrowing and blockages lead to strong pressure losses, with consequent starvation of the tissues depending on blood circulation. In this instance, LB has a technical, yet very important, point. When looking at the possible build-up of atherosclerotic plaques, the LB framework offers facilitated access to the wall shear stress tensor thereby dispensing with expensive and inaccurate finite-difference operations.

LB is today widely used to study biofluidics and blood ow. The fast turnaround makes it an excellent candidate for rapid screening in clinical practice, with the prospective possibility to even predict the outcome of clinical intervention. Stenting, angioplasty, ow diverting, aneurism wiring, to mention but a few, are all possible applications of the LB-MD methodology. Clearly, this is not the end of the story, as moving parts, as concerning valve placement or compliant vessel deformations can be taken into account by using the various schemes available today, starting from the IBM to handle the moving walls.

Microcirculation is interesting in itself. Due to the red blood cells constituents of blood that reaches up to 45% in volume in humans, two main concurrent effects take place: the Farhaeus-Lindqvist effect, whereby the average concentration of red blood cells decreases as the diameter of the containing vessel is decreased; the second effect is the viscosity change with the diameter of the vessel it travels through. The two effects arise because red blood cells move preferentially over the center of the vessel, leaving the plasma at the wall, thus lowering the near-wall dissipation effects. The Farhaeus-Lindqvist effect becomes visible in the range between 10 and 300 micrometers.

In capillaries of lateral size of 100 microns and below, the motion of red blood cells reveals highly non-trivial signatures of granularity and deformability. For capillaries with a diameter of a few microns, erythrocytes undergo large deformations in order to squeeze into the vessel and the globules are able to crawl into the micrometer-sized space. On the other hand, when looking at larger-scale circulation, in the 100-500 microns range, it is generally sufficient to consider blood cells as rigid bodies. The grand-challenge here is to reach up to physiological scales (1-10 cm) while retaining essential micro-features, the finite-size of red blood cells (8 micron) in the first place. This is of major interest for many reasons; the granular nature of blood may have a significant impact on the recirculation patterns in the proximity of natural geometrical irregularities, such as bifurcations, stenoses, aneurysms, or man-made ones, like stents and other medical devices.

Micro-to-macro hemodynamics is particularly rich, showing a peculiar distribution of oxygen-carrying cells at every bifurcation depending on the local Reynolds number, and with far reaching consequences on physiology. Erythrocytes exhibit both a tumbling motion and the tank-threading effect, whereby the cell membrane can slide under a shear force, two conditions that have deep impact on blood rheology. Plasma skimming near the arterial walls has important consequences on the local and global circulation in order to optimize the oxygen supply chain keeping, at the same time, the ow speed high in the capillaries. Further consequences relate to the most common of cardiovascular diseases since atherosclerosis depends on the uptake of lipidic material by the arterial wall and, ultimately on the near-wall shear stress. The discussion is still open and its outcome is extremely important to understand the causes of myocardial infarction for diagnostic or pre-emptive medicine.

Cellular hemodynamics is an open branch of research. A direct extension of the LB-MD method can account for suspended bodies, for the explicit presence of cells suspended in plasma.

This is a typical case where the hydrodynamic medium hosts particles with finite-size, anisotropic shape, in fact oblate ellipsoids, that represent red blood cells to first approximation. All LB assets show great value for deployment in hemodynamics.

Besides blood ow, LB applied to biofluidics is also witnessing medical applications to airways, ranging from nasal to pulmonary flows. This is yet another story, where compressibility effects become much less important and the focus shifts towards very intricate geometries in the presence of collapsible walls. Understanding how air flows in these regions, the consequence of rather small but crucial imperfections, the transport of small molecules or odorants, are all applications that draw great profits from the possibility of solving fluid mechanics in a multiphysics scenario in order to study peculiar conditions. Again, the Molecular Dynamics (MD) modeling and Lattice Boltzmann (LB) modeling of the systems and methods of the present disclosure are particularly well suited to computationally embrace to the presence of multiple agents in solution.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method for providing a multiscale simulation, the method comprising:
defining a visual representation as a plurality of individual and independent spatial regions;
defining, for at least one of the individual and independent spatial regions, movement of a structure and/or a fluid within the at least one of the individual and independent spatial regions at a first layer at a first spatial scale and at a second layer at a second spatial scale;
interconnecting the first and second layers so that movement at the first layer is synchronized with movement at the second layer in each of the plurality of individual and independent spatial regions; and
interconnecting the plurality of individual and independent spatial regions, thereby generating a multiscale simulation of the visual representation.

2. The method of claim 1, wherein visual representation of the structure and/or the fluid within the at least one of the individual and independent spatial regions at the first layer is generated from a first set of data and visual representation of the structure and/or the fluid within the at least one of the individual and independent spatial regions at the second layer is generated from a second set of data.

3. The method of claim 2, wherein the interconnecting the first and second layers comprises associating the first set of data with the second set of data.

4. The method of claim 2, wherein each of the first and second sets of data comprises structural data, dynamic data, behavioral data, and animation data associated with the structure and/or the fluid within the at least one of the individual and independent spatial regions.

5. The method of claim 4, wherein the simulation of the visual representation comprises an animation.

6. The method of claim 5, wherein the animation depicts an interaction of the structure with the fluid and/or an interaction of the structure with another structure.

7. The method of claim 5, wherein the movement of the structure and/or the fluid is based on the animation data.

8. The method of claim 7, wherein the animation data defines animation dynamics of or more portions of the structure and/or fluid based, at least in part, on one or more of the structural data, dynamic data, and behavioral data.

9. The method of claim 8, wherein at least one of the structural data, dynamic data, behavioral data, and animation data are sourced from one or more scientific data sources and the animation data allows for one or more portions of the structure to be deformed into one of a plurality of scientifically accurate poses.

10. The method of claim 1, wherein the structure is a biomolecule and the spatial scale is atomistic.

11. A system for providing a multiscale simulation, the system comprising:
a processor coupled to a memory containing instructions executable by the processor to cause the system to:
store a plurality of components associated at least one of a structure and a fluid to undergo simulation and a plurality of parameters for influencing movement of at least one of the structure and the fluid during simulation;
receive, via a graphical user interface, a request from a user, the request comprising selection of one or more components and one or more parameters;
define a visual representation as a plurality of individual and independent spatial regions based on the selected one or more components and parameters;
define, for at least one of the individual and independent spatial regions, movement of a structure and/or a fluid within the at least one of the individual and independent spatial regions at a first layer at a first spatial scale and at a second layer at a second spatial scale;
define, for the at least one of the individual and independent spatial regions, movement of the structure within the fluid based on a combination of structure dynamics and fluid dynamics so that movement of the structure within the fluid is based on interplay between the structure dynamics and the fluid dynamics, wherein the interplay is based on the structure exerting a density of field upon the fluid proportional to a gradient and the fluid exerting a density of field upon the structure proportional to the gradient;
interconnect the first and second layers so that movement at the first layer is synchronized with movement at the second layer in each of the plurality of individual and independent spatial regions; and
interconnect the plurality of individual and independent spatial regions, thereby generating a multiscale simulation of the visual representation.

12. The system of claim 11, wherein the structure dynamics is based on Molecular Dynamics modeling and the fluid dynamics is based on Lattice Boltzmann modeling.

13. The system of claim 11, wherein visual representation of the structure and/or the fluid within the at least one of the individual and independent spatial regions at the first layer is generated from a first set of data and visual representation of the structure and/or the fluid within the at least one of the individual and independent spatial regions at the second layer is generated from a second set of data.

14. The system of claim 13, wherein the interconnecting the first and second layers comprises associating the first set of data with the second set of data.

15. The system of claim 13, wherein each of the first and second sets of data comprises structural data, behavioral data, animation data, structure dynamics, and fluid dynamics associated with the structure and/or the fluid within the at least one of the individual and independent spatial regions.

16. The system of claim 15, wherein the simulation of the visual representation comprises an animation.

17. The system of claim 16, wherein the movement of the structure and/or the fluid is based on the animation data.

18. The system of claim 17, wherein the animation data defines animation dynamics of or more portions of the structure and/or fluid based, at least in part, on one or more of the structural data, dynamic data, and behavioral data in combination with the interplay between the structure dynamics and fluid dynamics.

19. The system of claim 18, wherein at least one of the structural data, behavioral data, animation data, and structure dynamics or fluid dynamics are sourced from one or more scientific data sources and the animation data allows for one or more portions of the structure to be deformed into one of a plurality of scientifically accurate poses.

20. The system of claim 11, wherein one or more of the plurality of parameters for influencing movement of at least one of the structure and the fluid during simulation are pre-programmed and one or more of the plurality of parameters are user-definable such that the system is configured to receive, via the graphical user interface, user-defined parameter settings and further configured to generate a simulation based on the selected one or more components the selected user-defined parameter settings.
